(19) United States
(12) Patent Application Publication
(10) Pub. No.: US 2017/0365030 A1
(43) Pub. Date: Dec. 21, 2017

(54) Systems and Methods for Vehicle Ridesharing Management

(71) Applicant: VIA TRANSPORTATION, INC., New York, NY (US)

(72) Inventors: Avishai P. Shoham, New York, NY (US); Alex J. Lavoi, New York, NY (US); Megan B. Richer, New York, NY (US); Erin H. Abrams, New York, NY (US); Daniel Ramot, New York, NY (US)

(73) Assignee: VIA TRANSPORTATION, INC., New York, NY (US)

(21) Appl. No.: 15/628,135

(22) Filed: Jun. 20, 2017

Related U.S. Application Data
(60) Provisional application No. 62/352,896, filed on Jun. 21, 2016.
(60) Provisional application No. 62/450,239, filed on Jan. 25, 2017.
(60) Provisional application No. 62/500,109, filed on May 2, 2017.
(60) Provisional application No. 62/509,376, filed on May 22, 2017.

(51) Int. Cl. G06Q 50/30; G06Q 10/02; G07B 15/02; G08G 1/00

(52) U.S. Cl. CPC G06Q 50/30; G08G 1/207; G06Q 10/02; G07B 15/02; G08G 1/202

(57) ABSTRACT

Systems and methods provide vehicle ridesharing and vehicle ridesharing management. In one implementation, a system includes a memory storing ridesharing-related instructions and at least one processor configured to execute the instructions to: receive, a first ride request from a first user, the first ride request including a first starting point and a first desired destination; send a confirmation to the first user with an indication of an estimated pick-up time; direct a taxi to pick up the first user; receive a second ride request from a second user; direct the taxi to pick up the second user; and send to the first user a fare amount including a first fare portion corresponding to a first portion of the ride before picking up the second user and a second fare portion corresponding to a second portion of the ride after picking up the second user.

### CROSS REFERENCES TO RELATED APPLICATIONS

This application claims the benefit of priority of U.S. Provisional Patent Application No. 62/352,896, filed June 21, 2016; U.S. Provisional Patent Application No. 62/450,239, filed Jan. 25, 2017; U.S. Provisional Patent Application No. 62/500,109, filed May 2, 2017; and U.S. Provisional Patent Application No. 62/509,376, filed May 22, 2017. All of the foregoing; applications are incorporated herein by reference in their entirety.

### BACKGROUND

### Technical Field

The present disclosure generally relates to the field of vehicle ridesharing and systems and methods for ridesharing management.

### Background Information

Recent years have witnessed increasing interest and development in the field of vehicle sharing, where one or more riders may share the same vehicle for a portion of their rides. Ridesharing may save ride costs, increase vehicle utilization, and reduce air pollution. Some riders may use ridesharing services through a ride service application on a mobile terminal. The rider may accept a proposed price, and subsequently be picked up by a vehicle. Other riders may share the same vehicle after the rider is picked up. However, the riders do not know the underlying ride fare calculation such as, for example, how the shared ride factors into the price calculation. Further, the riders do not have much flexibility in deciding the route or the price, such as whether to take toll roads, how many subsequent riders are to share the ride, or whether the rider is willing to walk to a certain location for quicker pick-up.

For these and other reasons, it is desirable to have systems and methods that provide efficient ridesharing management, enhanced flexibility and user experience, and optimal vehicle utilization.

### SUMMARY

Embodiments consistent with the present disclosure provide systems and methods for vehicle ridesharing and vehicle ridesharing management.

In one disclosed embodiment, a computer readable medium configured for use in a mobile device is provided. The computer readable medium may store instructions that, when executed by at least one processor associated with a taxi fleet, cause the at least one processor to perform a method for taxi ridesharing management. The method may include receiving a first ride request from a first wireless mobile communications device of a first user, the first ride request including a first starting point and a first desired destination; calculating a first estimated pick-up time based on a first current location of a taxi in the fleet and the first starting point; sending a first confirmation to the first wireless mobile communications device, the first confirmation being configured to cause an indication of the calculated first estimated pick-up time to appear on a display of the first wireless mobile communications device; guiding the taxi to a first pick-up location for picking up the first user; receiving, after picking up the first user and before dropping off the first user at a first drop-off location, a second ride request from a second wireless mobile communications device of a second user, the second ride request including a second starting point and a second desired destination; calculating a second estimated pick-up time based on a second current location of the taxi and the second starting point; sending a second confirmation to the second wireless mobile communications device, the second confirmation configured to cause an indication of the calculated second estimated pick-up time to appear on a display of the second wireless mobile communications device; and guiding the taxi to a second pick-up location for picking up the second user before dropping off the first user at a place associated with the first drop-off location.

In another disclosed embodiment, a system for taxi ridesharing management is provided. The system may include a memory storing a set of ridesharing-related instructions and at least one processor configured to execute the instructions to: receive, at a taxi ridesharing management server, a first ride request from a first user, the first ride request including a first starting point and a first desired destination; send a confirmation to the first user with an indication of an estimated pick-up time; direct a taxi to pick up the first user at a pick-up location; after pick-up of the first user, receive at the taxi ridesharing management server, a second ride request from a second user, the second ride request including a second starting point and a second desired destination; direct the taxi to pick up the second user at a second pick-up location while the first user is in the taxi; and send to the first user a fare amount including a first fare portion corresponding to a first portion of the ride before picking up the second user and a second fare portion corresponding to a second portion of the ride after picking up the second user.

The foregoing general description and the following detailed description are exemplary and explanatory only and are not restrictive of the claims.

### BRIEF DESCRIPTION OF THE DRAWINGS

The accompanying drawings, which are incorporated in and constitute part of this disclosure, illustrate various example embodiments. In the drawings:

FIG. 1 is a diagram illustrating an example ridesharing management system, in accordance with some embodiments of the present disclosure.

FIG. 2 is a diagram illustrating the components of an example computing device associated with a ridesharing management system, in accordance with some embodiments of the present disclosure.

FIG. 3 is a diagram illustrating the components of an example ridesharing management server associated with a ridesharing management system, in accordance with some embodiments of the present disclosure.

FIGS. 4A and 4B are flowcharts of example processes for vehicle ridesharing management, in accordance with some embodiments of the present disclosure.

FIG. 5 is a diagram of an example graphical user interface (GUI) displayed on a user device when requesting a ride, in accordance with some embodiments of the present disclosure.

FIGS. 6A and 6B are diagrams of example settings GUIs displayed on a user device, in accordance with some embodiments of the present disclosure.

FIG. 7 is a diagram of an example GUI displayed on a user device when receiving a confirmation, in accordance with some embodiments of the present disclosure.

FIGS. 8A and 8B are flowcharts of two example processes for calculating ride fares for a shared ride, in accordance with some embodiments of the present disclosure.

FIGS. 9A and 9B are diagrams of example GUIs displayed on a user device showing ride fare information, in accordance with some embodiments of the present disclosure.

FIG. 10 is a diagram of an example GUI displayed on a driver device, in accordance with some embodiments of the present disclosure.

FIG. 11 is a diagram of example timelines showing ridesharing arrangements, in accordance with some embodiments of the present disclosure.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions or modifications may be made to the components illustrated in the drawings, and the illustrative methods described herein may be modified by substituting reordering, removing, or adding steps to the disclosed methods. Accordingly, the following detailed description is not limited to the disclosed embodiments and examples. Instead, the proper scope is defined by the appended claims.

Disclosed embodiments of the present disclosure provide methods and systems for vehicle ridesharing and vehicle ridesharing management. The term “vehicle” as used herein refers to any kind of vehicle (e.g., car, van, SUV, truck, bus, etc.) suitable for human transportation, such as providing ride services. In some embodiments, a vehicle may be a taxi. In some embodiments, a taxi may be part of a fleet of taxis, such as a taxi that is part of a taxi service managed by a transportation service company or a taxi owned by an independent owner and used to providing ridesharing services. In some embodiments, a vehicle may include an autonomous vehicle, wherein a control device integrated with the vehicle or a management system separate from the vehicle may send operational instructions and guide the vehicle to designated locations for pick-ups and drop-offs. For the ease and conciseness of description, some embodiments disclosed herein may simply refer to a vehicle or a taxi as an example, which does riot limit the scope of the disclosed embodiments.

Consistent with some embodiments of the present disclosure, a ridesharing management system may receive a first ride request from a first user. The first ride request may include a starting point and a desired destination. The ridesharing management system may calculate a first estimated pick-up time based on a current location of a vehicle that is in the surrounding areas. After sending a confirmation with the estimated pick-up time, the ridesharing management system may then guide the vehicle to a pick-up location for picking up the first rider. The pick-up location may be a different location from the starting point included in the first ride request. The system may also guide the first user to the pick-up location.

In some embodiments, the system may subsequently receive a second ride request from a second user, for example, while the first user is still in the vehicle. The second ride request may include a second starting point and a second desired destination. The system may calculate a second estimated pick-up time, provide a second confirmation to the second rider, and guide the second rider to a second pick-up location, in some embodiments, the second pick-up location may be a different location from the second starting point included in the second ride request.

In some embodiments, the system may calculate the fares for each user, based on the solo ride portion for a corresponding user, and the shared portion of the ride. For example, the system may offer a discount for the shared portion of the ride. In some embodiments, the system may also calculate the fare amount for a particular user based on various service-related parameters such as user input regarding whether to toll roads, the walking distance between the starting point and the pick-up location, and the walking distance between the desired destination and the drop-off location.

The embodiments herein further include computer-implemented methods, tangible non-transitory computer-readable mediums, and systems. The computer-implemented methods can be executed, for example, by at least one processor that receives instructions from a non-transitory computer-readable storage medium. Similarly, systems and devices consistent with the present disclosure can include at least one processor and memory, and the memory can be a non-transitory computer-readable storage medium. As used herein, a “non-transitory computer-readable storage medium” refers to any type of physical memory on which information or data readable by at least one processor can he stored. Examples include random access memory (RAM), read-only memory (ROM), volatile memory, nonvolatile memory, hard drives, CD ROMs, DVDs, flash drives, disks, and any other known physical storage medium. Singular terms, such as “memory” and “computer-readable storage medium,” can additionally refer to multiple structures, such a plurality of memories or computer-readable storage mediums. As referred to herein, a “memory” may comprise any type of computer-readable storage medium unless otherwise specified. A computer-readable storage medium may store instructions for execution by at least one processor, including instructions for causing the processor to perform steps or stages consistent with an embodiment herein. Additionally, one or more computer-readable storage mediums may be used in implementing a computer-implemented method. The term “computer-readable storage medium” should be understood to include tangible items and exclude carrier waves and transient signals.

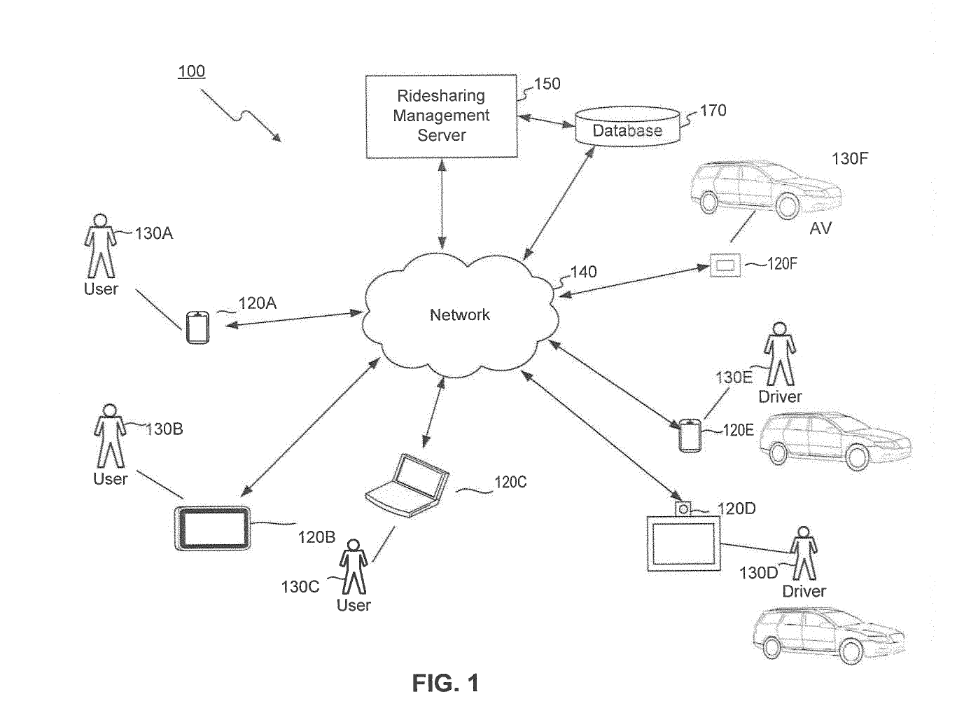

FIG. 1 is a diagram illustrating an example ridesharing management system, in which various implementations as described herein may be practiced, according to some embodiments of the present disclosure. As shown in FIG. 1, ridesharing management system 100 includes one or more computing devices 120A-120F (collectively referred to as computing devices 120), a network 140, a ridesharing management server 150, and a database 170. The plurality of computing devices 120A-120F may further include a plurality of user devices 120A-120C associated with users 130A-130C respectively, a plurality of driver devices 1201D and 120E associated with drivers 130D and 130E, and a driving-control device 120F associated with an autonomous vehicle 130F. Consistent with some embodiments of the, present disclosure, ridesharing management server 150 may communicate with driving-control device 120F to direct autonomous vehicle 130F to pick up and drop off users 130A-130C. In one example, autonomous vehicles capable of detecting objects on the road and navigate to designated locations may be utilized for providing ridesharing services.

The components and arrangements shown in FIG. 1 are not intended to limit the disclosed embodiments, as the system components used to implement the disclosed processes and features can vary. For example, ridesharing management system 100 may include multiple ridesharing management servers 150, and each ridesharing management server 150 may handle a certain category of ridesharing services, ridesharing services associated with a certain category of service vehicles, or ridesharing services in a specific geographical region, such that a plurality of ridesharing management servers 150 may collectively provide a dynamic and integrated ridesharing service system.

Network 140 may facilitate communications between user devices 120 and ridesharing management server 150, for example, receiving ride requests and other ride server related input from or sending confirmations to user devices, and sending ride service assignments to driver devices and driving-control devices. Network 140 may be any type of networks that provides communications, exchanges information, and/or facilitates the exchange of information between ridesharing management server 150 and user devices 120. For example, network 140 may be the Internet, a Local Area Network, a cellular network, a public switched telephone network (“PSTN”), or other suitable connection(s) that enables ridesharing management system 100 to send and receive information between the components of ridesharing management system 100. Network 140 may support a variety of messaging formats, and may further support a variety of services and applications fur user devices 120. For example, network 140 may support navigation services for computing devices 120, such as directing the users and service vehicles to pick-up or drop-off locations.

Ridesharing management server 150 may be a system associated with a communication service provider which provides a variety of data or services, such as voice, messaging, real-time audio/video, to users, such as users 130A-130E. Ridesharing management server 150 may be a computer-based system including computer system components, desktop computers, workstations, tablets, hand held computing devices, memory devices, and/or internal network(s) connecting the components. Ridesharing management server 150 may be configured to receive information from computing devices 120 over network 140, process the information, store the information, and/or transmit information to computing devices 120 over network 140.

For example, in some embodiments, ridesharing management server 150 may be configured to: receive ride requests from user devices 120A-120C, send ride confirmation and ride fare information to user devices 120A-120C, and send ride service assignments (for example, including pick-up and drop-off location information) to driver devices 120D and 120E, and driving-control device 120F. Further, ridesharing management server 150 may further be configured to receive user input from user devices 120A-120C as to various ride service parameters, such as walking distance to a pick-up location, maximum delay of arrival/detour, and maximum number of subsequent pick-ups, etc. In some embodiments, ridesharing management server 150 may be further configured to: calculate ride fares based on a solo portion of a user's ride and a shared portion of the ride. Further, the ride fare calculation may further be based on various ride service parameters set by the user, such as the walking distance involved in the ride, and user selection regarding toll road usage, etc.

Database 170 may include one or more physical or virtual storages coupled with ridesharing management server 150. Database 170 may be configured to store user account information (including registered user accounts and driver accounts), corresponding user profiles such as contact information, profile photos, and associated computing device information. With respect to users, user account information may further include ride history, service feedbacks, complaints, or comments. With respect to drivers, user account information may further include number of ride service assignments completed, ratings, and ride service history information. Database 170 may further be configured to store various ride requests received from user devices 120A-120C and corresponding starting point and desired destination information, user input regarding various service parameters, pick-up and drop-off locations, time of pick-up and drop-off, ride fares, and user feedbacks, etc.

Database 170 may further include traffic data, maps, and toll roads information, which may be used for ridesharing service management. Traffic data may include historical traffic data and real-time traffic data regarding a certain geographical region, and may be used to, for example, calculate estimate pick-up and drop-off times, and determine an optimal route for a particular ride. Real-time traffic data may be received from a real-time traffic monitoring system, which may be integrated in or independent from ridesharing management system 100. Maps may include map information used for navigation purposes, for example, for calculating potential routes and guiding the users to a pick-off or drop-off location. Toll roads information may include toll charges regarding certain roads, and any change or updates thereof. Toll roads information may be used to calculate ride fares, for example, in cases where the user permits use of toll roads.

The data stored in database 170 may be transmitted to ridesharing management server 150 for accommodating ride requests. In some embodiments, database 170 may be stored in a cloud-based server (not shown) that is accessible by ridesharing management server 150 and/or computing devices 120 through network 140. While database 170 is illustrated as an external device connected to ridesharing management server 150, database 170 may also reside within ridesharing management server 150 as an internal component of ridesharing management server 150.

As shown in FIG. 1, users 130A-130E may include a plurality of users 130A-130C, and a plurality of drivers 130D and 130E, who may communicate with one another, and with ridesharing management server 150 using various types of computing devices 120. As an example, a computing device 120 may include a display such as a television, tablet, computer monitor, video conferencing console, or laptop computer screen. A computing device 120 may further include video/audio input devices such as a microphone, video camera, keyboard, web camera, or the like. For example, a computing device 120 may include mobile devices such as a tablet or a smartphone having display and video/audio capture capabilities. A computing device 120 may also include one or more software applications that Facilitate the computing devices to engage in communications, such as IM, VoIP, video conferences. For example, user devices 130A-130C may send requests to ridesharing management server 150, and receive confirmations therefrom. Drivers 130D and 130E may use their respective devices to receive ride service assignments and navigation information from ridesharing management server 150, and may contact the users with their respective devices 120D and 120E.

In some embodiments, a user may directly hail a vehicle by hand gesture or verbal communication, such as traditional street vehicle hailing. In such embodiments, once a driver accepts the request, the driver may then use his device to input the ride request information. Ridesharing management server 150 may receive such request information, and accordingly assign one or more additional ride service assignments to the same vehicle, for example, subsequent e-hail ride requests received from other computing devices 120 through network 140.

In some embodiments, driver devices 120D and 120E, and driving-control device 120F may he embodied in a vehicle control panel, as a part of the vehicle control system associated with a particular vehicle. For example, a traditional taxi company may install a drive device in all taxi vehicles managed by the taxi company. In some embodiments, driver devices 120D and 120E, and driving-control device 120F, may be further coupled with a payment device, such as a card reader installed as a part of the vehicle control panel or as a separate device associated with the vehicle. A user may then use the payment device as an alternative payment mechanism. For example, a user who hails the taxi on the street may pay through the payment device, without using a user device providing ridesharing service.

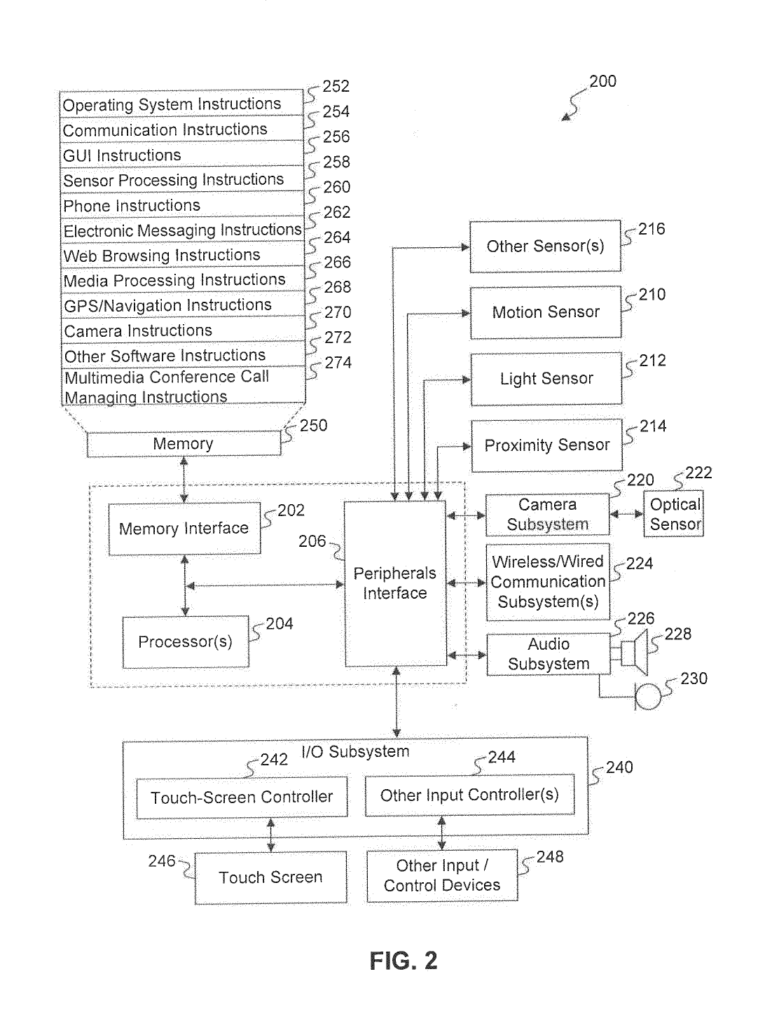

FIG. 2 is a diagram illustrating the components of an example computing device 200 associated with a ridesharing management system, such as system 100 as shown in FIG. 1, in accordance with some embodiments of the present disclosure. Computing device 200 may he used to implement computer programs, applications, methods, processes, or other software to perform embodiments described in the present disclosure, such as computing devices 120A-120F. For example, user devices 120A-120C, driver devices 120D and 120E, and driving-control device 120F may respectively be installed with a user side ridesharing application, and a corresponding driver side ridesharing application.

Computing device 200 includes a memory interface 202, one or more processors 204 such as data processors, image processors and/or central processing units, and a peripherals interface 206. Memory interface 202, one or more processors 204, and/or peripherals interface 206 can be separate components or can be integrated in one or more integrated circuits. The various components in computing device 200 may be coupled by one or more communication buses or signal lines.

Sensors, devices, and subsystems can be coupled to peripherals interface 206 to facilitate multiple functionalities. For example, a motion sensor 210, a light sensor 212, and a proximity sensor 214 may be coupled to peripherals interface 206 to facilitate orientation, lighting, and proximity functions. Other sensors 215 may also be connected to peripherals interface 206, such as a positioning system (e.g., GPS receiver), a temperature sensor, a biometric sensor, or other sensing device, to facilitate related functionalities. A UPS receiver may be integrated with, or connected to, computing device 200. For example, a GPS receiver may be included in mobile telephones, such as smartphone devices, GPS software may allow mobile telephones to use an internal or external GPS receiver (e.g., connecting via a serial port or Bluetooth). A camera subsystem 220 and an optical sensor 222, e.g., a charged coupled device (“CCD”) or a complementary metal-oxide semiconductor (“CMOS”) optical sensor, may be used to facilitate camera functions, such as recording photographs and video clips.

Communication functions may be facilitated through one or more wireless/wired communication subsystems 224, which includes a Ethernet port, radio frequency receivers and transmitters and/or optical (e.g., infrared) receivers and transmitters. The specific design and implementation of wireless/wired communication subsystem 224 may depend on the communication network(s) over which computing device 200 is intended to operate. For example, in some embodiments, computing device 200 may include wireless/wired communication subsystems 224 designed to operate over a GSM network, a GPRS network, an EDGE network, a Wi-Fi or WiMax network, and a Bluetooth® network.

An audio subsystem 226 may be coupled to a speaker 228 and a microphone 230 to facilitate voice-enabled functions, such as voice recognition, voice replication, digital recording, and telephony functions.

I/O subsystem 240 may include touch screen controller 242 and/or other input controller(s) 244. Touch screen controller 242 may be coupled to touch screen 246. Touch screen 246 and touch screen controller 242 may, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with touch screen 246. While touch screen 246 is shown in FIG. 2, I/O subsystem 240 may include a display screen (e.g., CRT or LCD) in place of touch screen 246.

Other input controller(s) 244 may be coupled to other input/control devices 248, such as one or more buttons, rocker switches, thumb-wheel, infrared port, USB port, and/or a pointer device such as a stylus. Touch screen 246 may, for example, also be used to implement virtual or soft buttons and/or a keyboard.

Memory interface 202 may be coupled to memory 250. Memory 250 includes high-speed random access memory and/or non-volatile memory, such as one or more magnetic disk storage devices, one or more optical storage devices, and/or flash memory (e.g., NAND, NOR). Memory 250 may store an operating system 252, such as DRAWIN, RTXC, LINUX, iOS UNIX, OS X, WINDOWS, or an embedded operating system such as VXWorkS. Operating system 252 may include instructions for handling basic system services and for performing hardware dependent tasks. In some implementations, operating system 252 can be a kernel (e.g., UNIX kernel).

Memory 250 may also store communication instructions 254 to facilitate communicating with one or more additional devices, one or more computers and/or one or more servers. Memory 250 can include graphical user interface instructions 256 to facilitate graphic user interface processing; sensor processing instructions 258 to facilitate sensor-related processing and functions; phone instructions 260 to facilitate phone-related processes and functions; electronic messaging instructions 262 to facilitate electronic-messaging related processes and functions; web browsing instructions 264 to facilitate web browsing-related processes and functions; media processing instructions 266 to facilitate media processing-related processes and functions; GPS/navigation instructions 268 to facilitate GPS and navigation-related processes and instructions; camera instructions 270 to facilitate camera-related processes and functions; and/or other software instructions 272 to facilitate other processes and functions.

In some embodiments, communication instructions 254 may include software applications to facilitate connection with ridesharing management server 150 that handles vehicle ridesharing requests. Graphical user interface instructions 256 may include a software program that facilitates a user associated with the computing device to receive messages from ridesharing management server 150, provide user input, and so on. For example, a user may send ride requests and ride service parameters to ridesharing management server 150 and receive ride confirmation messages. A driver may receive ride service assignments from ridesharing management server 150, and provide ride service status updates.

Each of the above identified instructions and applications may correspond to a set of instructions for performing one or more functions described above. These instructions need not be implemented as separate software programs, procedures, or modules. Memory 250 may include additional instructions or fewer instructions. Furthermore, various functions of computing device 200 may be implemented in hardware and/or in software, including in one or more signal processing and/or application specific integrated circuits.

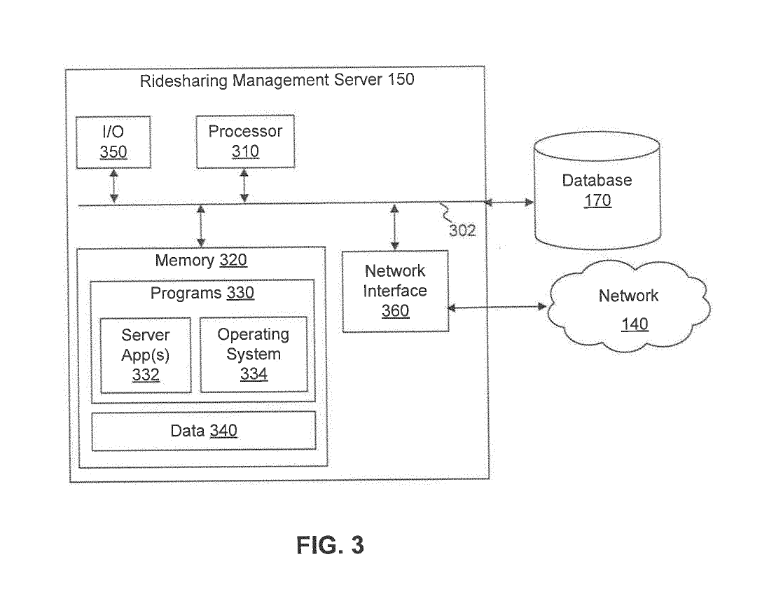

FIG. 3 is a diagram illustrating the components of an example ridesharing management server associated with a ridesharing management system, such as system 100 as shown in FIG. 1, in accordance with some embodiments of the present disclosure. Ridesharing management server 150 may include a bus 302 for other communication mechanism), which interconnects subsystems and components for transferring information within ridesharing management server 150.

As shown in FIG. 3, ridesharing management server 150 may include one or more processors 310, input/output (“I/O”) devices 350, network interface 360 (e.g., a modem, Ethernet card, or any other interface configured to exchange data with a network, such as network 140 in FIG. 1), and one or more memories 320 storing programs 330 including, for example, server app(s) 332, operating system 334, and data 340, and may communicate with an external database 170 (which, for some embodiments, may be included within ridesharing management server 150). Ridesharing management server 150 may be a single server or may be configured as a distributed computer system including multiple servers, server farms, clouds, or computers that interoperate to perform one or more of the processes and functionalities associated with the disclosed embodiments.

Processor 310 may be one or more processing devices configured to perform functions of the disclosed methods, such as a microprocessor manufactured by Intel™ or manufactured by AMD™. Processor 310 may comprise a single core or multiple core processors executing parallel processes simultaneously. For example, processor 310 may be a single core processor configured with virtual processing technologies. In certain embodiments, processor 310 may use logical processors to simultaneously execute and control multiple processes. Processor 310 may implement virtual machine technologies, or other technologies to provide the ability to execute, control, run, manipulate, store, etc. multiple software processes, applications, programs, etc. In some embodiments, processor 310 may include a multiple-core processor arrangement (e.g., dual, quad core, etc.) configured to provide parallel processing functionalities to allow ridesharing management server 150 to execute multiple processes simultaneously. It is appreciated that other types of processor arrangements could be implemented that provide for the capabilities disclosed herein.

Memory 320 may be a volatile or non-volatile, magnetic, semiconductor, tape, optical, removable, non-removable, or other type of storage device or tangible or non-transitory computer-readable medium that stores one or more program(s) 330 such as server apps 332 and operating system 334, and data 340. Common forms of non-transitory media include, for example, a flash drive a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same.

Ridesharing management server 150 may include one or more storage devices configured to store information used by processor 310 (or other components) to perform certain functions related to the disclosed embodiments. For example, ridesharing management server 150 may include memory 320 that includes instructions to enable processor 310 to execute one or more applications, such as server apps 332, operating system 334, and any other type of application or software known to be available on computer systems. Alternatively or additionally, the instructions, application programs, etc. may be stored in an external database 170 (which can also be internal to ridesharing management server 150) or external storage communicatively coupled with ridesharing management server 150 (not shown), such as one or more database or memory accessible over network 140.

Database 170 or other external storage may be a volatile or non-volatile, magnetic, semiconductor, tape, optical, removable, non-removable, or other type of storage device or tangible or non-transitory computer-readable medium. Memory 320 and database 170 may include one or more memory devices that store data and instructions used to perform one or more features of the disclosed embodiments. Memory 320 and database 170 may also include any combination of one or more databases controlled by memory controller devices (e.g., server(s), etc.) or software, such as document management systems. Microsoft SQL databases, SharePoint databases, Oracle™ databases, Sybase™ databases, or other relational databases.

In some embodiments, ridesharing management server 150 may be communicatively connected to one or more remote memory devices (e.g., remote databases (not shown)) through network 140 or a different network. The remote memory devices can be configured to store information that ridesharing management server 150 can access and/or manage. By way of example, the remote memory devices may include document management systems, Microsoft SQL database, SharePoint databases, Oracle™ databases, Sybase™ databases, or other relational databases. Systems and methods consistent with disclosed embodiments, however, are not limited to separate databases or even to the use of a database.

Programs 330 may include one or more software modules causing processor 310 to perform one or more functions of the disclosed embodiments. Moreover, processor 310 may execute one or more programs located remotely from one or more components of the ridesharing management system 100. For example, ridesharing management server 150 may access one or more remote programs that, when executed, perform functions related to disclosed embodiments.

In the presently described embodiment, server app(s) 332 may cause processor 310 to perform one or more functions of the disclosed methods. For example, devices associated with users, drivers and autonomous vehicles may respectively be installed with user applications for vehicle ridesharing services, and driver applications for vehicle ridesharing services. Further, a computing device may be installed with both the driver applications and the user applications, for uses in corresponding situations.

In some embodiments, other components of ridesharing management system 100 may be configured to perform one or more functions of the disclosed methods. For example, computing devices 120 may be configured to calculate estimate pick-up and drop-off times based on a certain ride request, and may be configured to calculate estimate ride fares. As another example, computing devices 120 may further be configured to provide navigation service, and location service, such as directing the user to a particular pick-up or drop-off location, and providing information about a current location of the respective user or vehicle to ridesharing management server 150.

In some embodiments, program(s) 330 may include operating system 334 performing operating system functions when executed by one or more processors such as processor 310. By way of example, operating system 334 may include Microsoft Windows™, Unix™, Linux™, Apple™ operating systems, Personal Digital Assistant (PDA) type operating systems, such as Apple iOS, Google Android, Blackberry OS, Microsoft CE™, or other types of operating systems. Accordingly, the disclosed embodiments may operate and function with computer systems running any type of operating system 334. Ridesharing management server 150 may also include software that, when executed by a processor, provides communications with network 140 through network interface 360 and/or a direct connection to one or more computing devices 120A-120F.

In some embodiments, data 340 may include, for example, profiles of users, such as user profiles or driver profiles. Data 340 may further include ride requests from a plurality of users, user ride history and driver service record, and communications between a driver and a user regarding a particular ride request. In some embodiments, data 340 may further include traffic data, toll roads information, and navigation information, which may be used for handling and accommodating ride requests.

Ridesharing management server 150 may also include one or more I/O devices 350 having one or more interfaces for receiving signals or input from devices and providing signals or output to one or more devices that allow data to be received and/or transmitted by ridesharing management server 150. For example, ridesharing management server 150 may include interface components for interfacing with one or more input devices, such as one or more keyboards, mouse devices, and the like, that enable ridesharing management server 150 to receive input from an operator or administrator (not shown).

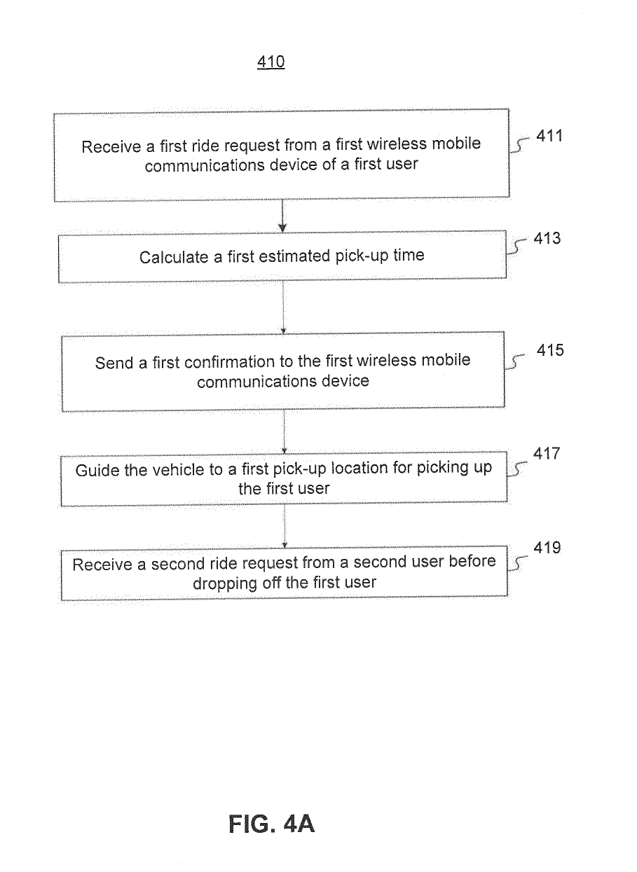

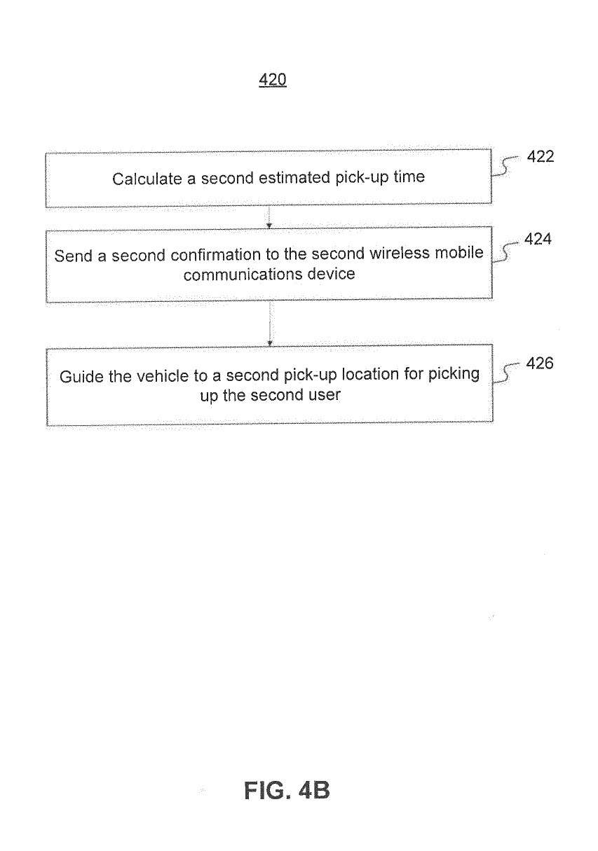

FIGS. 4A and 413 are flowcharts of example processes 410 and 420 for vehicle ridesharing management, in accordance with some embodiments of the present disclosure. In some embodiments, the vehicle may include taxi vehicles in a taxi fleet. In one embodiment, all of the steps of process 400 may be performed by a ridesharing management server, such as ridesharing management server 150 described above with reference to FIGS. 1 and 3. Alternatively, at least some of the steps of process 400 may be performed by a computing device, such as the computing devices 120 described above with reference to FIGS. 1 and 2. In the following description, reference is made to certain components of FIGS. 1-3 for purposes of illustration. It will be appreciated, however, that other implementations are possible and that other components may be utilized to implement example methods disclosed herein.

At step 411, ridesharing management server 150 may receive a first ride request from a first wireless communication of a first user, for example, a request from user 130 sent through user device 120A. The first ride request may include a first starting point and a first desired destination. A ride request may refer to a request from a user needing transportation service from a certain location to another. A starting point may refer to a current location of the user, as input by the user through an input device of an associated user device, or as determined by a location service application installed on the user device. In some embodiments, the starting point may he a location different from the current location of the user, for example, a location where the user will subsequently arrive at (e.g., entrance of a building). A desired destination may refer to a location where the user requests to be taken to.

In some embodiments, the actual pick-up location and the actual drop-off location may be different from the starting point and the desired destination. For example, the pick-up location may be of a certain distance from the starting point, where the user may be directed to for pick-up. By encouraging the user to walk to a pick-up location nearby, consistent with some embodiments, the vehicle may more easily and quickly locate the user without excessive detour, or causing excessive delay for users who are in the vehicle. Similarly, by encouraging the user to walk from a drop-off Location different from but within a certain distance from the desired destination, the vehicle may be able to accommodate subsequent pick-ups, or arrive at the subsequent pick-up locations more quickly. The vehicle ridesharing service management system may provide incentives or rewards for the user who are willing to walk a certain distance. For example, the ridesharing management system may offer certain discounts based on the number and distances of the walks involved in a particular ride. Alternatively, the ridesharing management system may offer ride credits corresponding to the number and distance of the walks undertaken by the user during his rides. The user may use the credits for subsequent ride payment, or redeem the credit for money, free rides, or other rewards. Further, advantages of such embodiments may include more efficient vehicle use and management, more user flexibility, and less air pollution associated with vehicle use.

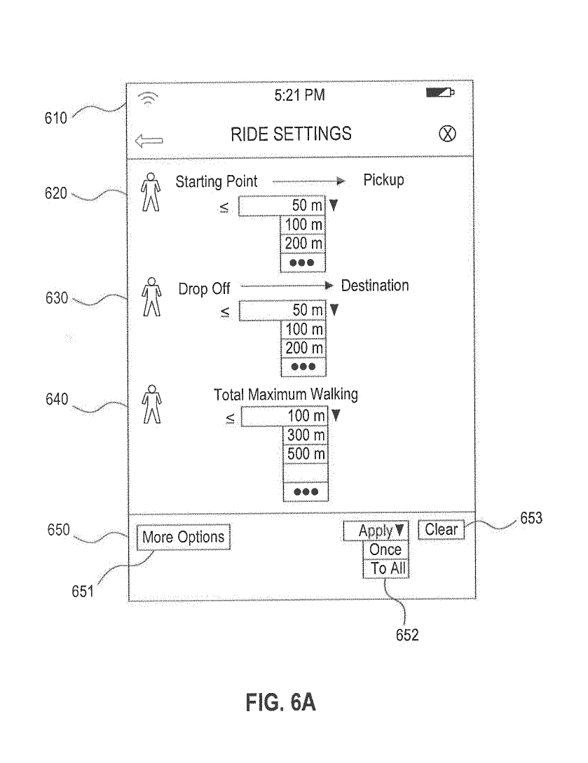

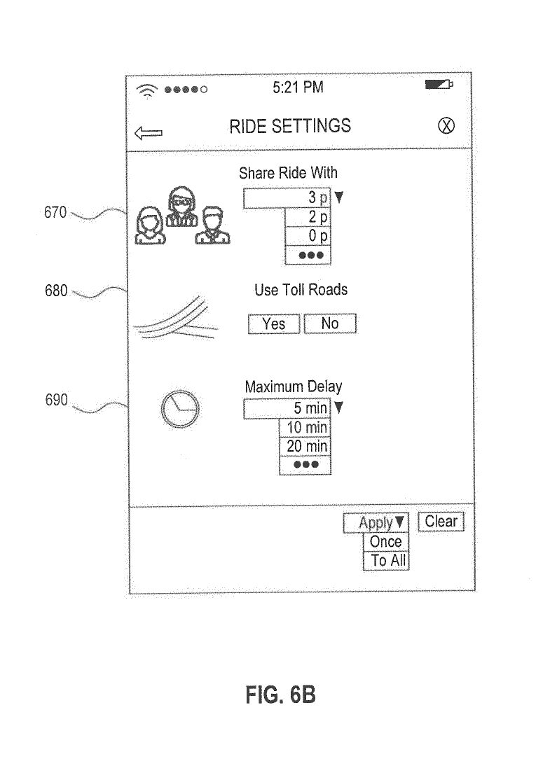

In some embodiments, prior to or after the user sends a ride request to ridesharing management server 150, the user may further input ride service parameters through, for example, a settings component provided on a user interface. Ride service parameters refer to user preference parameters regarding a vehicle ridesharing service, for example, a maximum walking distance from the starting point to a pick-up location, a maximum walking distance from a drop-off location to a desired destination, a total maximum walking distance involved in a ride, a maximum number of subsequent pick-ups, maximum delay of arrival/detour incurred by subsequent pick-ups during a ride, and a selection whether to permit toll road usage during the ride, etc. Example ride setting user interfaces will be further described herein with reference to FIGS. 6A and 6B.

Ride service parameters may he transmitted to ridesharing management server 150 for processing the request and assignment of an available vehicle based on the ride service parameters. For example, a ride request nay be associated with a maximum walking distance of 300 meters from a starting point to a pick-up location. When assigning an available vehicle to pick up the user, ridesharing management server 150 may include in the assignment an assigned pick-up location within 300 meters or less of the starting point. Similarly, a ride request may he associated with a maximum walking distance of 0.5 mile from a drop-off location to a desired destination. When assigning an available vehicle to pick up the user, ridesharing management server 150 may include in the assignment an assigned drop-off location within 0.5 mile or less from the desired destination.

For requests associated with a maximum total walking distance of 1 mile during the ride, when assigning an available vehicle to pick up the user, vehicle management server 150 may include in the assignment an assigned pick-up location and an assigned drop-off location, and a total of a distance from the starting point to the assigned pick-up location and a distance from the assigned drop-off location to a desired destination may be equal to or less than 1 mile.

In the above examples, the values regarding the walking distances are only exemplary. Other embodiments consistent with the present disclosure may use different options of the distances and may provide a list of options. The distances may further be measured in different units, for example, miles, meters, kilometers, blocks, and feet, etc., which are not limited by the disclosed embodiments herein. In some embodiments, the distance may tither be represented by an average walking time from a certain location to another, based on average walking speed, for example, 10 minutes, 5 minutes, etc.

With respect to parameters regarding subsequent pick-ups, such as a maximum number of subsequent pick-ups, and maximum delay of arrival incurred by subsequent pick-ups. Ridesharing management server 150 may assign subsequent pick-ups accordingly, without exceeding the parameters set by the user. For example, a ride request may be associated with a maximum number of 2 subsequent pick-ups during the ride. Ridesharing management server 150 may monitor the service status of the vehicle assigned to pick up the user, and refrain from assigning a third subsequent pick-up before the vehicle arrives at the a drop-off location for dropping off the user. As another example, for a ride request associated with a maximum delay of arrival of 10 minutes, when assigning subsequent ride requests, ridesharing management server 150 may calculate an estimated delay that may occur to the user if the same vehicle was to undertake the subsequent ride request. If the estimated delay that may occur to the user is more than 10 minutes, ridesharing management server 150 may assign the subsequent ride request to other available vehicles.

In some embodiments, the user may also input selection of toll road usage through the associated user device, to allow or disallow use of toll roads. Ridesharing management server 150 may then take the user's selection into account when assigning an available vehicle for accommodating the ride request, determining travel route, and calculating ride fare for the user. For example, ridesharing management server 150 may adjust the ride fare amount for a corresponding user based on the toll roads selection input and toll charges involved. For another example, if a first user does not permit toll road usage, before any subsequent pick-ups during the ride, ridesharing management server 150 may send a route to an assigned vehicle that does not include toll roads. For another example, if a subsequent user sharing the ride permits usage of toll road, ridesharing management server 150 may not charge the first user for any overlap portion of the ride where toll roads are used, change the route to include toll roads after the first user is dropped off, or assign the second user to a ridesharing vehicle with users that permit toll road usage.

in some embodiments, the ride request information may also be input from the driver device, for example, driver device 120D, or from a device associated with the vehicle. In the case of street hailing, where the user hails a vehicle on the street without using a vehicle ridesharing service application on a computing device. The driver, for example, driver 130D may input information such as the starting point/pick-up information and destination information through driver device 120D, which may then be transmitted to ridesharing management server 150.

At step 413, ridesharing management server 150 may calculate an estimated pick-up time, for example, based on a current location of an assigned vehicle and the first starting point included in the first ride request. An estimated pick-up time may refer to a time period before an assigned vehicle arrives at a pick-up location for picking up the user.

The assigned vehicle may refer to the vehicle that is assigned to undertake the first ride request, for example, a taxi in a taxi fleet, one of a plurality of vehicles managed by a transportation service system, or a plurality of vehicles owned by a plurality of owners and used to provide ridesharing services. The pick-up location may be the same as the starting point, or an assigned pick-up location associated with the starting point.

The estimated pick-up time may be determined based on a distance between a current location of the assigned vehicle and the pick-up location, and an estimate speed of traveling along, the route between the two locations. The current location of the assigned vehicle may be determined by a location service application installed on a driver device, a driving-control device, or by a location determination component in the ridesharing management system 100, which may be a part of or separate from ridesharing management server 150. In some embodiments, the estimated pick-up time may further be determined based on historical or real-time traffic data, and a route currently followed by the vehicle.

in some embodiments, process 410 may further include locating one or a plurality of potential available vehicles, and selecting an assigned vehicle therefrom. For example, potential available vehicles may include vacant vehicles in the surrounding areas of the first starting point, and vehicles heading to a location close to the first starting point for assigned pick-ups or drop-offs. Ridesharing management server 150 may filter potential available vehicles by ride service parameters set by the users who are inside the vehicle, for example, removing occupied vehicles where the a user inside the vehicle does not permit subsequent pick-ups, or occupied vehicles where the user requires a minimal delay. In some embodiments, ridesharing management server 150 may filter potential assignment vehicles by choosing a vehicle that would involve minimal walking of the user, or walking without the need of crossing the street. In some embodiments, ridesharing management server 150 may further filter potential assignment vehicles by choosing a vehicle that would involve minimal detour for the vehicle to arrive at the pick-up location. In some embodiments, the assigned vehicle may be selected by applying multiple filter criteria, or by applying multiple filter criteria in a certain order.

In some embodiments, the pick-up location may be an assigned pick-up location different from the first starting point, for example, half a block or further away from the first starting point. Ridesharing management server 150 may assign a pick-up location based on ride service parameters set by the first user, as described above at step 411. Ridesharing management server 150 may further assign a pick-up location which is along a main street where an assigned vehicle can easily locate, or a location which would not require an assign vehicle to take a U-Turn. In cases where there are one or more other users in the vehicle, ridesharing management server 150 may assign a pick-up location close to the vehicle's next assigned drop-off, or on the side of a street where the vehicle will soon go through. In some embodiments, ridesharing management server 150 may adjust selection of the pick-up location based on filtering results of potential assignment vehicles, or vice versa. The two selection processes may complement each other to reach one or more optimal combinations.

in some embodiments, where there are multiple potential assignment vehicles, each with a corresponding potential pick-up location, an estimated pick-up time may be respectively calculated corresponding to each of the potential assignment vehicles. Ridesharing management server 150 ma then choose the vehicle with the shortest estimated pick-up time to be the assigned vehicle.

At step 415, ridesharing management server 150 may send a first confirmation to a user device associated with the first user, which is, in this example, user device 120A. The first confirmation may be configured to cause an indication of the calculated first estimated pick-up time to appear on a display of user device 120A. The confirmation may appear in different formats, for example, a text message including the estimated pick-up time, an audio message, or an image, the specific implementation of which are not limited by the disclosed embodiments herein.

In some embodiments, if ridesharing management server 150 assigns a pick-up location different from the starting point, the confirmation may further cause the display of an indication of the assigned pick-up location. Ridesharing management server 150 may further provide a navigation option which may be displayed on a user interface. A selection of the navigation option may then guide the user to the assigned pickup location for pick-up.

in some embodiments, if ridesharing management server 150 assigns a drop-off location different from the desired destination, the confirmation may further cause a display of an indication of the assigned drop-off location. The confirmation may further cause a display of an indication of an estimated walking distance from the starting point to the assigned pick-up location, and an estimated walking distance from the assigned drop-off location to the desired destination. The assigned drop-off location may be a location close to the desired destination, within the maximum walking distance parameters set by the first user. For example, the drop-off location may be at a location half a block away or further from the desired destination, and may be along a main street where the vehicle may easily locate and access. For another example, the drop-off location may be determined based on a route towards the next pick-up location, such that the vehicle may easily drop off the first user on its way to the next pick-up location, thereby avoiding an extra detour.

In some embodiments, the confirmation may further include information about the assigned vehicle, and the driver associated with the vehicle. For example, the vehicle information may include the license plate number, brand, color, or model of the vehicle. The driver information may include name, nickname, profile photo, ratings, number of previous rides, and contact information of the driver. The confirmation may further include a contact option allowing the user to contact the driver, for example, a “contact the driver” button which the user may click to initiate a communication session with the driver.

At step 417, ridesharing management server 150 may guide the assigned vehicle to the first pick-up location for picking up the first user. For example, ridesharing management server 150 may transmit direction information to the driver device associated with the assigned vehicle, for example, driver device 120D or driving-control device 120F. In some embodiments, a navigation component of the driver device, or the driving-control device may perform the step of guiding the vehicle to the first pick-up location. Correspondingly, ridesharing management server 150, or a navigation component of the user device 120A, may guide the user to the first pick-up location, in cases where the pick-up location is an assigned pick-location different from the first starting point. For example, for autonomous vehicles used for ridesharing services, such as autonomous vehicle 130F as shown in FIG. 1, the vehicle itself may be capable of using a variety of techniques to detect its surroundings, identify feasible paths, and navigate without direct human input.

In some embodiments, once the vehicle is assigned to pick up the user, ridesharing management server 150 may assign a communication channel for the driver associated with the assigned vehicle to communicate with the user, for example, a masked phone number. In some embodiments, a user interface of a driver device, such as driver device 120D, may include an option to send notification messages to the user, for example, a pre-defined message button of “I'm here.” Once the vehicle arrives at the pick-up location, the driver may click the message button to send the message to the user. This way, the driver may not need to dial out or type a message in order to notify the user of the vehicle's arrival, reducing driver distraction and associated safety hazards.

At step 419, ridesharing management server 150 may receive a second ride request from a second user. In some embodiments, the second user request may he a street hailing request received directly by the vehicle while the first user is still inside, namely, before dropping off the first user. The vehicle may then undertake the second ride request, if the first user permits subsequent pick-ups. In some embodiments, the driver of the vehicle may input the second ride request information through a driver device, for example, driver device 120D associated with driver 130D. The input may inform ridesharing management server 150 that the vehicle has undertaken a second ride request, or may further include the pick-up location and destination information of the second user. Ridesharing management server 150 may then accordingly determine whether to assign additional pick-ups to the same vehicle, and may further send direction information guiding the vehicle to the second user's destination.

In some embodiments, the second ride request may be received by ridesharing management server 150 from a second wireless mobile communications device, for example, user device 120B associated with user 130B as shown in FIG. 1. The second ride request may further include a second starting point, and a second desired destination. Ridesharing management server 150 may then assign a corresponding ride service to an available vehicle, which may he the vehicle that has picked up the first user, before dropping off the first user. In processing the second ride request, the example process 420 as shown in FIG. 4B may be performed.

At step 422, ridesharing management server 150 may calculate a second estimated pick-up time, for example, based on a second current location of the vehicle and the second starting point. The second estimated pick-up time may refer to an estimated time period before the vehicle arrives at a second pick-up location for picking up the second user. The second pick-up location may be an assigned pick-up location different from, but associated with the second starting point. Assignment of the second pick-up location may include similar steps as described above with reference to FIG. 4A, details of which is not repeated herein.

At step 424, ridesharing management server 150 may send a second confirmation to the second wireless mobile communication device, which is user device 120B in this example. The second confirmation may be configured to cause an indication of the calculated second estimated pick-up time to appear on a display of the second wireless mobile communication device. As described above with reference to FIG. 4A, the confirmation may appear in different formats, and may further cause a display of information regarding a second pick-up location, a second drop-off location, and walking distance and walking directions from the second starting point to the second pick-up location and/or from the second drop-off location to the second desired destination, etc., the details of which is not repeated herein.

In some embodiments, ridesharing management server 150 may set the second pick-up location at substantially the same location as the first pick-up location, for example, half a block away, or 100 meters away from the first pick-up location. This way, the vehicle may pick up both users at about the same time at substantially the same location, further improving service efficiency. In some embodiments, ridesharing management server 150 may set the second pick-up location at a substantially the same location as the first drop-off location, wherein the vehicle may drop off the first user, and pick up the second user at about the same time, without extra travelling. Further, in some embodiments, the second drop-off location may be set at substantially the same location as the first drop off location, such that the vehicle may drop off multiple users at the same time.

In some embodiments, ridesharing management server 150 may set the first pick-up location to substantially differ from the first starting point, and the second pick-up location to substantially differ from the second starting point, for example, to ensure both pick-up locations are along the same side of the same street where the vehicle may go through. Ridesharing management server 150 may then send respective directions to the first user device and the second user device, to guide the users to the respective pick-up locations.

in some embodiments, ridesharing management server 150 may set the first pick-up location at substantially the same as the first starting point, and set the second pick-up location to substantially differ from the second starting point. For example, the selection of the pick-up locations may be made such that the first pick-up location and the second pick-up location are close to one another, both pick-up locations are along the same street, or the second pick-up location is close to the first drop-off location. Ridesharing management server 150 may then send respective directions to the first user device and the second user device, to guide the users to the respective pick-up locations.

At step 426, ridesharing management server 150 may guide the vehicle to a second pick-up location for picking up the second user. As described above with reference to FIG. 4A, this step may also he performed by a navigation component of the driver's device (e.g., driver device 120D, or driving-control device 120F associated with autonomous vehicle 130F).

In some embodiments, ridesharing management server 150 may change the first drop-off location after receiving the second ride request, and the change may be made without pre-approval of the first user. The first drop-off location refers to a location for dropping off the first user. As described above with reference to FIG. 4A, the first drop-off location may be the same as the first desired destination, or at a location different from the first desired destination,

For example, the second pick-up location may be set at a location close to the first desired destination, included in the first ride request. When assigning the second ride request to the vehicle, ridesharing management server 150 may change the first drop-off location to a location closer to or at the first desired destination, thus reducing the walking distance for the first user to arrive at his desired destination. For another example, the first drop-off location may be changed to a location where the first user does not need to cross the street to arrive at his desired destination, without causing or increasing detour for the vehicle to arrive at the second pick-up location.

In some embodiments, ridesharing management system 100 may subsequently receive a plurality of subsequent ride requests. These additional ride requests may either be received by ridesharing management server 150 and assigned to the vehicles, or received by the vehicles in the form of street hailing. Steps described above with reference to FIGS. 4A and 4B may similarly be used to process the third ride request,

For example, ridesharing management server 150 may receive a third ride request from a third user device, for example, user device 120C associated with user 130C, as shown in FIG. 1. Ridesharing management server 150 may process the request and assign the request to the vehicle while at least one of a first user and a second user is still in the vehicle. The third ride request may further include a third starting point and a third desired destination. Ridesharing management server 150 may calculate a third estimated pick-up time, and send a confirmation to a user's device (e.g., user device 120C). Ridesharing management server 150 may transmit direction and route information to the driver's device associated with the vehicle (e.g., driver device 120D as shown in FIG. 1), to guide the vehicle to pick up and drop off user 130C.

As described above with reference to FIGS. 4A and 4B, processing of subsequent ride requests may take into account of the ride service parameters set by the users whose requests have previously been received and assigned. For example, if both the first user and the second user are still in the vehicle, and one of them has set a maximum delay of arrival, ridesharing management server 150 may not assign the third request to the same vehicle if such assignment would cause a delay longer than the set value. For example, if the first user has set a maximum delay of arrival of 10 minutes, ridesharing management server 150 may calculate an estimated time period it takes for the vehicle to pick up (and/or drop off) the third user before dropping off the first user if the estimated time would cause a total delay of arrival for the first user to exceed 10 minutes, ridesharing management server 150 may therefore assign the third ride request to another vehicle. For another example, if the second user has set a maximum number of 1 co-rider and the second user will be dropped off earlier than the first user, ridesharing management server 150 may not assign to the same vehicle, as such assignment may cause violation of the parameter (maximum number of 1 co-rider) set by the second user.

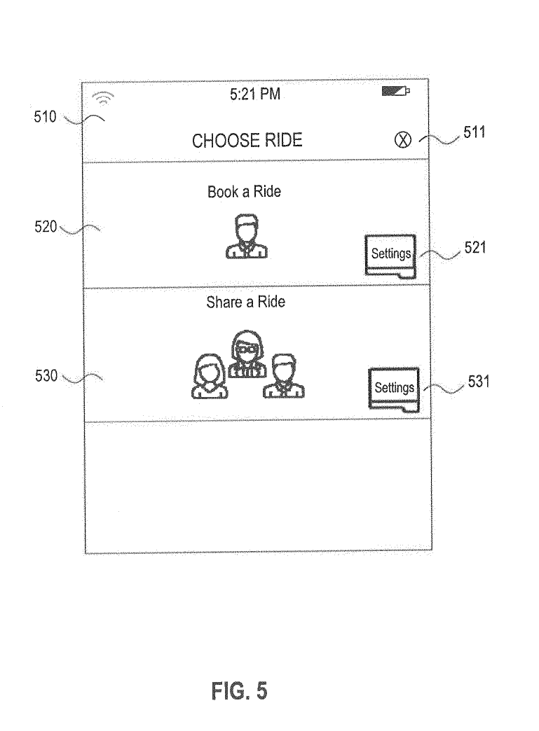

FIG. 5 is a diagram of an example graphical user interface (GUI) displayed on a user device, for example, user device 120A, when requesting a ride, in accordance with some embodiments of the present disclosure. As shown in FIG. 5, the GUI may include title section 510, solo ride section 520, and shared ride section 530.

Title section 510 may further include icons indicating internet access, time and battery power of the device. Title section 510 may further include a cancel icon 511, a selection of which may cancel the ride the user is editing, or exiting from the page.

Solo ride section 520 indicates an option to book a solo ride, with no additional pick-ups before the user is dropped off. Solo ride section 520 may further include a settings button 521, a selection of which may cause the display of a list of setting options for the user to input or select ride service parameters, such as those described above with reference to FIG. 4A. Setting button 521 may link to a separate settings GUI where the user may input or select ride service parameters. Example settings GUIs will be further described with reference to FIGS. 6A and 6B.

Shared ride section 530 indicates an option to book a shared ride, where additional pick-ups and/or drop-offs may be allowed. Shared ride section 530 may further include a settings button 531, a selection of which may cause the display of a list of setting options for the user to input or select ride service parameters, such as those described above with reference to FIG. 4A. Setting button 531 may link to a separate settings GUI where the user may input or select ride service parameters. Example settings GUIs will be further described with reference to FIGS. 6A and 6B.

In some embodiments, the GUI described above in connection with FIG. 5 may further include other components, and different arrangements and combinations of components, consistent with other embodiments of the present disclosure, which are not limited by the disclosed embodiments herein. For example, the GUI may further include a user profile section, which indicates the user's account information, such as profile photo, user name, and contact information.

In some embodiments, a plurality of ride service options may be provided when a user is booking a ride. Details related to each option, such as assigned pick-up and drop-off locations, or ride fares associated with each option, may be presented on a user interface. For example, after the user inputs a starting point and a desired destination, a taxi ride sharing management server may provide a plurality of service options based on current service status of a plurality of vehicles. For example, the taxi ridesharing management server may calculate a first estimated pick-up time for a solo ride service, the first estimated pick-up time corresponding to a first pick-up location; and a second estimated pick-up time for a ridesharing service, the second estimated pick-up time corresponding to a second pick-up location. In some embodiments, a plurality of ridesharing service options corresponding to different ride service parameters may further be provided, for example, an option with no more than one additional pickup, an option with a 5 minute delay, or options associated with other ride service parameters described below with reference to FIGS. 6A and 6B. Ride fares associated with each option may further be presented through the user interface. The ridesharing management server may receive a service option as indicated by user input, and assign a vehicle accordingly,

FIGS. 6A and 6B are diagrams of example settings GUIs displayed on a user device, for example, user device 120A as shown in FIG. 1. The settings may include settings regarding ride service parameters, based on which ridesharing management server 150 may assign a vehicle to accommodate the ride request. As shown in FIG. 6A, one example settings GUI may include title section 610, walking distance sections 620-640, and application section 650.

Title section 610 may include icons indicating page title, internet connection, time, and battery power. Title 610 may further include a return icon, a selection of which may cause the display of a previous page; and a cancel icon, a selection of which may cause cancellation of the settings, or exiting from the current page.

Walking distance sections 620-640 may further include settings options regarding walking distances involved in the ride. For example, walking distance section 620 may indicate options regarding a walking distance from a starting point of the ride included in the ride request, and a pick-up location. Section 620 may further include a list of options indicating different walking distance values. The walking distance may be measured in different units, for example, meters, blocks, miles, kilometers, feet and so on, the selection of which is not limited by the disclosed embodiments herein. In some embodiments, the distance may further be represented by an average walking time based on average walking speed, for example, 10 minutes or 5 minutes from the starting point to the pick-up location. Similarly, walking distance section 630 may indicate options regarding a walking distance from a drop-off location to a desired destination included in the ride request. Section 640 may indicate options regarding a total of a walking distance from the starting point to the pick-up location, and a distance from the drop-off location to the desired destination.

Application section 650 may further include more options icon 651, a selection of which may cause a display of settings option regarding other ride service parameters; an apply icon 652, which may further include an option of applying the current settings once, and an option of applying the current settings to all ride requests; and a clear button 653, a selection of which may clear the current settings and allow the user to reset.

As shown in FIG. 6B, other ride service parameters may further include co-rider number section 670, toll roads section 680, and maximum delay/detour section 690. The GUI as shown in FIG. 6B may he displayed upon a selection of the more options button 650 as shown in FIG. 6A. In some embodiments, settings options as shown in FIG. 6B and other settings options may be shown on the same GUI, and may be arranged in various manners, which are not limited by the disclosed embodiments herein.

Co-rider number section 670 may further include settings options regarding the number of additional riders to share the same vehicle with the user for a portion of the user's ride. Toll roads section 680 may further include option buttons indicating whether the user permits use of toll roads during the ride. In some embodiments, if a co-rider permits the use of toll roads while another does not, the vehicle may take toll roads for the permitted portion of the ride, without charging the user who does not permit use of toll roads. Maximum delay section 690 may further include option buttons indicating a time period of permitted delay of arrival at a drop-off location.

In some embodiments, user device 120A may save default settings regarding one or more of the ride service parameters. The delimit settings may be the parameters set for a previous ride of the user, or settings determined by ridesharing management server 150. For example, in cases where the user inputs or selects some, but not all of the parameters, ridesharing management server 150 may refer to the non-conflicting default settings regarding other parameters when handling the ride request.

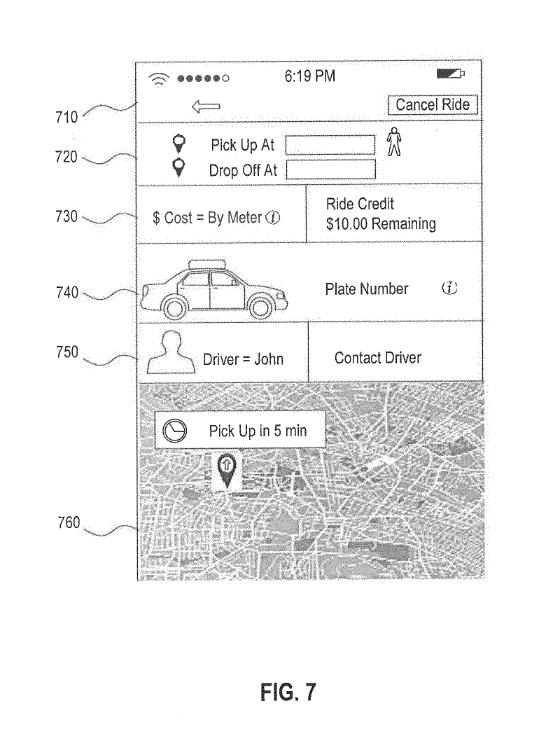

FIG. 7 is a diagram of an example GUI displayed on a user device, fee example, user device 120A as shown in FIG. 1, when receiving a confirmation, in accordance with some embodiments of the present disclosure. As shown in FIG. 7, the example GUI may include title section 710, location section 720, fare section 730, vehicle information section 740, driver information section 750, and map section 760.

Title section 710 may further include icons indicating internet connection, time, and battery power, etc. Title section 710 may further include a return button, a selection of which may cause the display of the previous page; and a cancel ride button, a selection of which may cancel the ride, or cause the display of a cancel ride page where the user may provide further information such as the reason of cancellation, or an option to reset the ride request.

Location section 720 may further include information regarding the pick-up location and drop-off location for the current ride. The location information may be shown in different formats. For example, the location information may include detailed description as to a general distance or route between the starting point and an assigned pick-up location, such as “half a block from 20 & H Street,” or “300 meters east from the E Street Theater, next to the dry cleaner store.” This way, the user may easily recognize how to reach the pick-up location. In some embodiments, the location information may further include a walk icon linking to a map directing the user to the pick-up or drop-off location from a current location.

Fare section 730 may further include an estimated cost section showing an estimated ride fare amount fur the ride. The cost section may further include an information icon, a selection of which may cause the display of details regarding the estimated cost, such as base fare, estimate toll charges and taxes, etc. Details regarding the estimated cost may further include information regarding savings corresponding to ride service parameters of the ride, for example, an amount to be saved due to a walking distance of 500 meters from the drop-off location to the desired destination, or an amount saved due to a maximum permitted delay of 30 minutes. Fare section 730 may further include a ride credit section, which shows the amount of ride credit associated with the user account. The ride credit may be in the form of monetary value which the user may use to pay for the current or future rides, or a form of reward credit which the user may redeem for certain rewards.

Vehicle information section 740 may include information about the assigned vehicle to pick up the user. Vehicle information may include the license plate number of the vehicle, number of rides the vehicle has served, and ratings of the vehicle, etc.

Driver information section 750 may include information about the driver, such as name, profile photo, contact information, ratings of the driver, etc. Driver information section 750 may further include a contact driver section, a selection of which may initiate a communication session such as text messaging, phone call, or other communication channel for the user to communication with the driver. In some embodiments, a masked phone number may be assigned for the communication between the driver and the user, for purposes such as safety control or monitoring.

Map section 760 may include a map indicating locations involved in the ride, such as the current location of the user and the vehicle, the pick-up and drop off location, and the desired destination, etc. Map section 760 may further include an icon indicating an estimated pick-up time.

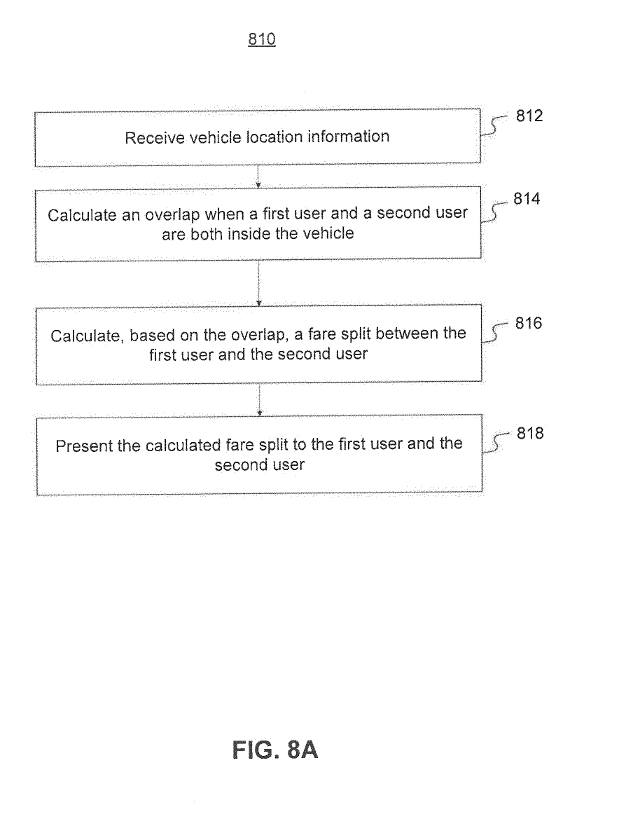

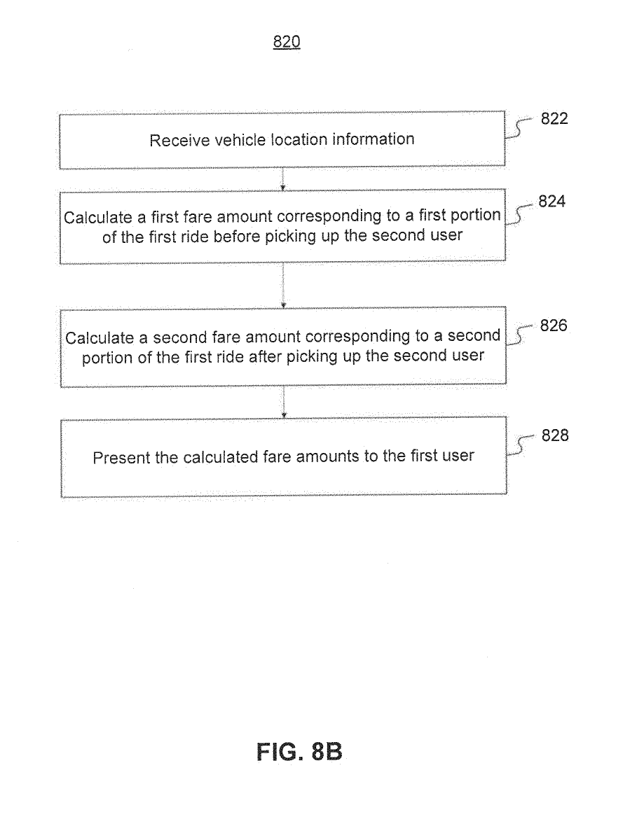

FIGS. 8A and 8B are flowcharts of two example processes 810 and 820, respectively, for calculating ride fares for a shared ride, in accordance with some embodiments of the present disclosure. In these two examples, a ride shared by a first user and a second user is taken as an example. The processes 810 and 820 may be performed, for example, by ridesharing management server 150 as shown in FIG. 1, or may alternatively be performed by the computing devices, for example, user devices 120A and 120B.

At step 812, ridesharing management server 150 may receive vehicle location information, for example, the vehicle location may be transmitted from the first user device 120A, the second user device 120B, or a device associated with the vehicle, for example, driver device 120D. In some embodiments, the vehicle may include a taxi in a taxi fleet. The vehicle location information may include pick-up and drop-off locations of the first user and the second user, and location information of the vehicle during the ride.

At step 814, ridesharing management server 150 may calculate an overlap when the first user and the second user are both inside the vehicle. For example, the overlap may correspond with a portion of the ride between the pick-up location of the second user and the drop-off location of the user who is the first to be dropped off.

At step 816, ridesharing management server 150 may calculate, based on the overlap, a fare split between the first user and the second user. For the shared portion of the ride, the corresponding fare may be shared by the first user and second user, wherein each user enjoys a discount. The discount may be the same or different for the first user and the second user, which may depend on factors such as the walking involved in the rides for each user, the total ride distance of each user, total number of rides taken by each user, and other ride service parameters set by each user. In some embodiments, where there are three or more users sharing a portion of the ride, the fare amount for each user may be further reduced correspondingly.

In some embodiments, for the solo portion of the ride, the user may be charged for the whole or discounted amount, taking into consideration of the total ride distance of the solo portion, toll charges involved, traffic wait time during the ride, walking involved, and a number of previous rides taken by the user, etc. The ridesharing management server 150 may then calculate the total fare amount for each user.

At step 818, ridesharing management server 150 may present the calculated fare split to the first user and the second user. For example, ridesharing management server 150 may respectively send to user device 120A and 120B, fare information regarding the shared portion and details of the split, fare information regarding the solo portion for each user, other charges involved for each user, and the total fare amount for each user.

FIG. 8B is another example process of calculating ride fare for a first user, who shares a portion of the ride with a second user.

At step 822, ridesharing management server 150 may receive vehicle location information, for example, the vehicle location may be transmitted from the first user device 120A, the second user device 120B, a device associated with the vehicle, for example, driver device 120D. The vehicle location information may include pick-up and drop-off locations of the first user and the second user, and location information of the vehicle during the ride. In some embodiments, ridesharing management server 150 may constantly monitor the location of the vehicle, and may update fare charges in real-time as the ride progresses.

At step 824, ridesharing management server 150 may calculate a first fare amount corresponding to a first portion of the first ride before picking up the second user. For example, the first user may be the only user in the vehicle before the picking up the second user, the first fare amount may include the gas charges and toll charges if toll road use is permitted. In some embodiments, the ridesharing management server may update in real-time as the fare charges as the vehicle travels, and transmit the fare information to a user's device (e.g., user device 120A). The user may monitor the increase of the fare in real-time. For example, a ridesharing service application installed on user devices may include a personal meter feature, through which up-to-the-minute ride fare information may be displayed. The ride fare information may include relevant fare charges for a particular user, which are calculated based on discounts applied for the ride, surcharges, tips, and other fees involved in booking the ride. In some embodiments, the ride fare information may further be updated periodically according to a pre-set interval, such as every minute, or every few seconds.

At step 826, ridesharing management server 150 may calculate a second fare amount corresponding to a second portion of the first ride after picking up the second user. For example, for the shared portion of the ride after the second user is picked up, a discount may be applied respectively for the first user and the second user. The ridesharing management server may calculate an amount corresponding to a travel distance of the shared portion, and the discount applied to the first user.

At step 828, ridesharing management server 150 may transmit the calculated fare amounts to the user device, which may be presented on a display of the user device 120A. In some embodiments, where the first user is not using a user device, for example, the first user may requested the ride through street hailing, the fare amounts may be displayed on a display device associated with the vehicle.

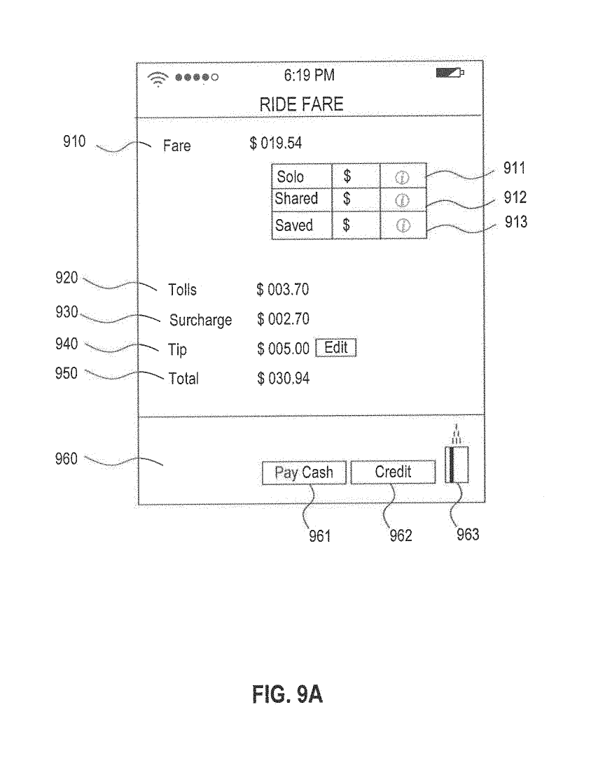

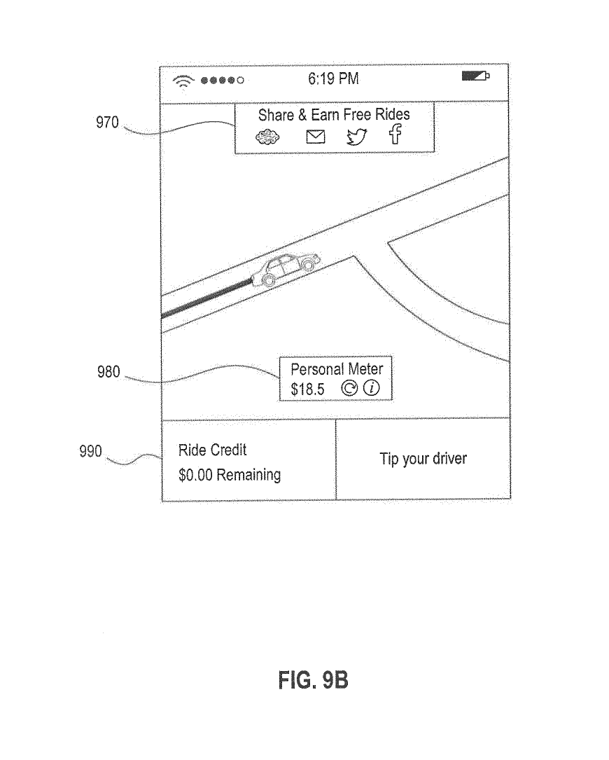

FIGS. 9A and 9B are diagrams of example GUIs displayed on a user device showing ride fare information, in accordance with some embodiments of the present disclosure. The example GUIs may be displayed, for example, on a display of user device 120A, before or after the user is dropped off. In some embodiments, the example GUIs may further be displayed on a device associated with the vehicle.

As shown in FIG. 9A, one example GUI may further include fare section 910, tolls section 920, surcharge section 930, tip section 940, total fare section 950, and payment section 960.

Fare section 910, which may further include subsection 911 indicating details regarding fare charge for the solo portion of the ride, subsection 912 indicating details regarding the shared portion of the ride 912, and subsection 913 indicating details regarding amounts saved due to the shared portion or other ride service parameters set by the user. Subsections 911, 912, and 913 may further include information icons for each charge, through which details of calculation of each individual charge may be displayed to the user. For example, a selection of the information icon corresponding to the shared portion may cause a display of the distance of the shared portion, starting and end point of the shared portion, toll charges involved during the shared portion, and discounts applied for the shared portion.

Tolls section 920 may include information of toll charge amount(s) involved in the full or solo portion of the ride. Surcharge section 930 may include information of surcharges, such as taxes. Tip section 940 may include tip information input by the user, and may further include an edit button through which the user may adjust the tip amount. Total fare section 950 may include information of the full amount charged for the ride.

Payment section 960 may include icons for different forms of payment. For example, payment section 960 may further include a pay cash button 961, where the user may select and indicate that the user will pay cash for his ride; a credit button 962, through which the user may use ride credits associated with the user account to pay for his ride; and a card payment button 963, which may link to pages processing payments by a debit or credit card.

In some embodiments, real-time charge information may be displayed on the user's device (e.g., user device 120A) through a personal meter for an associated user. One example is herein described with reference to FIG. 9B. As shown in FIG. 9B, one example GUI may include share section 970, personal meter 980, and ride credit section 990.

Share section 970 may include icons linking to different communication applications, through which the user may share information about their ride, or the ridesharing service. For example, such icons may include text message, emails, and social media platforms such as Twitter and Facebook. In some embodiments, ridesharing management server 150 may award the user ride credits or discounts, for sharing information about the ridesharing service.

Personal meter 980 may include information about real-time fare charge information. For example, ridesharing management server 150 may constantly monitor the location and service status of the vehicle, and calculate fare charges, for example, by performing the processes described above with reference to FIGS. 8A and 8B. The updated fare charge information may then he transmitted to the user device 120A, and may be displayed on the personal meter 980. Personal meter 980 may further include a refresh icon, which may allow the user to refresh the page to display fare charge updates; and an information icon, which may allow the user to access detailed information regarding the fare charge.

Ride credit section 990 may include information indicating the amount of ride credit associated with the user account. In cases where the user uses the ride credit to pay for the current ride, ride credit section 990 may further include real-time ride credit information with real-time fare charge deducted therefrom. The example GUI shown in FIG. 9B may further include a tip-your-driver icon, through which the user may adjust the tip amount any time during the ride.

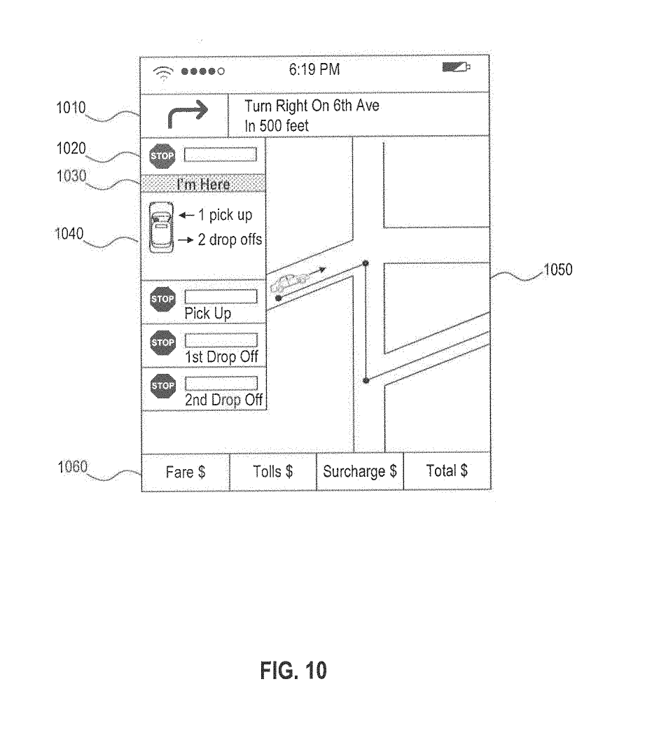

FIG. 10 is a diagram of an example GUI displayed on a driver device, for example, driver device 120D as shown in FIG. 1, in accordance with some embodiments of the present disclosure. As shown in FIG. 10, the example GUI may include direction section 1010, next stop section 1020, notification message section 1030, assignment information section 1040, map section 1050, and fare charge information section 1060.

Direction section 1010 may include direction information guiding the driver to the next pick-up or drop-off location. Next stop section 1020 may include address information of the next stop. Notification message section 1030 may include one or more pre-formatted notification messages, a selection of which may cause the transmission of the corresponding message to the user device. For example, notification message section 1030 may include a message “I'm here,” indicating the vehicle's arrival at a pick-up location. After arriving at a particular location, the driver may click the icon associated with the message, which causes a corresponding notification to be sent to the user. This way, the driver may easily notify the user of the vehicle's arrival by clicking an icon, without the need for preparing the message, or calling the user.

Assignment information section 1040 may include detailed information of the current ride service assignment, which may include the current status of the ride service assignment, and pick-up and drop-off locations involved in the ride. Map section 1050 may display in real-time the current location of the vehicle, and the route of the ride. For example, the location information may be provided by a location service application installed on the user device, a device associated with the vehicle, or a location tracking component at the ridesharing management server some embodiments, ridesharing management server 150 may assign additional ride requests to the vehicle, detailed information may then he transmitted to the driver device 120D, and displayed in corresponding sections. Fare charge information section 1060 may include fare charge details such as fare, tolls, surcharges, and total amount of the ride fare.

In some embodiments, before assigning ride requests to a vehicle, ridesharing management server 150 may further require the driver to provide verification information. For example, for drivers associated with a vehicle service management system, such as ridesharing management system 100 as shown in FIG. 1, the system may require every driver to register a driver account with corresponding profile information, such as contact information, profile photo, emails, voice data, facial features data, log in information, and information associated with a vehicle assigned to the driver. The driver profiles may be saved in a database, for example, database 170 as shown in FIG. 1. Before assigning ride requests to the vehicle, ridesharing management server 150 may receive driver log in input from an associated driver device, for example, user device 120D associated with driver 130D. The ridesharing management server 150 may then access the driver profile database to verify whether the log in input matches a corresponding driver profile. Further, verification may be implemented in various manners, for example, facial recognition, voice recognition, fingerprint recognition, password input, and verification code input, etc., which are not limited by the disclosed embodiments herein.

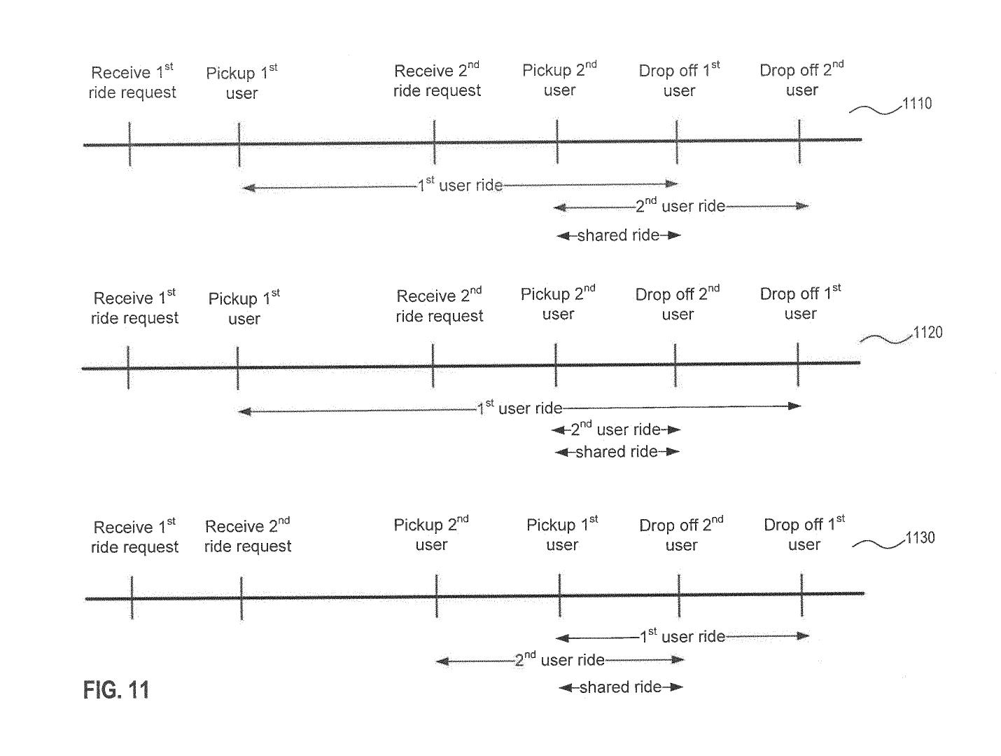

FIG. 11 is a diagram of three example timelines showing ridesharing arrangements, in accordance with some embodiments of the present disclosure. As shown in example timelines 1110, 1120, and 1130, for a particular assigned vehicle undertaking a first ride request from a first user and a second ride request from a second user, the order of pick-ups and drop-offs for the second user may vary. For example, ridesharing management server 150 may receive a plurality of ride requests, design an optimal path and pick-up/drop-off order for a particular assigned vehicle undertaking multiple requests, and assign additional pick-ups as the vehicle completes a part of or all of the ride requests.

For example, as shown in example timeline 1110, a vehicle may receive a second ride request after picking up the first user, and drop off the first user before dropping off the second user. A corresponding shared ride portion may be the portion of ride between the pick-up of the second user and drop-off of the first user. As shown in example timeline 1120, the vehicle may receive a second ride request after picking up the first user, and drop off the second user before dropping off the first user. A corresponding shared ride portion may be the portion of ride between the pick-up of the second user and drop-off the second user,

As another example, as shown in example timeline 1130, the vehicle may receive the first ride request and the second ride request before any pick-up. The vehicle may then pick up the second user before picking up the first user, and drop off the second user before dropping off the first user. A corresponding shared ride portion may be the portion of ride between pick-up of the first user and drop-off of the second user. Depending on the order of pick-ups and drop-offs, the ridesharing management server may then determine a corresponding shared ride portion, and calculate ride fare for each user based on, for example, the shared portion, solo portion of each user, and/or other factors such as the ride service parameters set by each user.

The foregoing description has been presented for purposes of illustration. It is not exhaustive and is not limited to the precise forms or embodiments disclosed. Modifications and adaptations will he apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices, e.g., hard disks or CD ROM, or other forms of RAM or ROM, USB media, DVD, Blu-ray, Ultra HD Blu-ray, or other optical drive media.

Computer programs based on the written description and disclosed methods are within the skills of an experienced developer. The various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

1. A non-transitory computer-readable storage medium storing instructions that, when executed by at least one processor associated with a taxi fleet, cause the at least one processor to perform a method for taxi ridesharing management, the method comprising:
receiving a first ride request from a first wireless mobile communications device of a first user, the first ride request including a first starting point and a first desired destination;
calculating a first estimated pick-up time based on a first current location of a taxi in the fleet and the first starting point;
sending a first confirmation to the first wireless mobile communications device, the first confirmation being configured to cause an indication of the calculated first estimated pick-up time to appear on a display of the first wireless mobile communications device;
guiding the taxi to a first pick-up location for picking up the first user;
receiving, after picking up the first user and before dropping off the first user at a first drop-off location, a second ride request from a second wireless mobile communications device of a second user, the second ride request including a second starting point and a second desired destination;
calculating a second estimated pick-up time based on a second current location of the taxi and the second starting point;
sending a second confirmation to the second wireless mobile communications device, the second confirmation configured to cause an indication of the calculated second estimated pick-up time to appear on a display of the second wireless mobile communications device; and
guiding the taxi to a second pick-up location for picking up the second user before dropping off the first user at a place associated with the first drop-off location.

2. The non-transitory computer-readable storage medium according to claim 1, wherein the instructions are configured to cause the at least one processor to set the first pick-up location at least a half a block away from the first starting point.

3. The non-transitory computer-readable storage medium according to claim 2, wherein the instructions are configured to cause the at least one processor to set a maximum walking distance to the first pick-up location based on input from the first wireless mobile communications device.

4. The non-transitory computer-readable storage medium according to claim 1, wherein the instructions are configured to cause the at least one processor to set the first drop-off location at least a half a block away from the desired destination.

5. The non-transitory computer-readable storage medium according to claim 4, wherein the instructions are configured to cause the at least one processor to set a maximum walking distance based on input from the first wireless mobile communications device.

6. The non-transitory computer-readable storage medium according to claim 1, wherein the instructions are configured to cause the at least one processor to calculate the first estimated pick-up time based on real-time traffic information received from a real-time traffic monitor.

7. The non-transitory computer-readable storage medium according to claim 1, wherein the instructions are configured to cause the at least one processor to calculate the first estimated pick-up time based on prediction of traffic condition based on historical traffic data.

8. The non-transitory computer-readable storage medium according to claim 1, the method further comprising:
changing the first drop-off location after receiving the second ride request, without pre-approval of the first user.

9. The non-transitory computer-readable storage medium according to claim 1, the method further comprising:
receiving taxi location information from at least one of a wireless mobile communications device associated with the taxi, the first wireless mobile communications device, and the second communications device;
calculating an overlap when the first user and the second user are both inside the taxi;
calculating, based on the overlap, a fare split between the first user and the second user; and
presenting at least one indication of the calculated fare split on each of the display of the first wireless mobile communications device and the display of the second wireless mobile communications device.

10. The non-transitory computer-readable storage medium according to claim 1, the method further comprising:
calculating a first fare amount corresponding to a first portion of the first ride before picking up the second user;
calculating a second fare amount corresponding to a second portion of the first ride after picking up the second user; and
transmitting, for presentation on the display of the first wireless mobile communications device, at least one indication of the first fare amount and the second fare amount.

11. The non-transitory computer-readable storage medium according to claim 1, the method further comprising:
receiving a toil roads selection input from at least one of the first wireless mobile communications device and the second wireless mobile communications device; and
adjusting fare amount for a corresponding user based on the toll roads selection input and toll charges incurred.

12. The non-transitory computer-readable storage medium according to claim 1, the method further comprising:
receiving a third ride request, while at least one of the first user and the second user is in the taxi, from a third wireless mobile communications device of a third user, the third ride request including a third starting point and a third desired destination;
calculating a third estimated pick-up time based on a third current location of the taxi and the third starting point;
sending a third confirmation to the third wireless mobile communications device, the third confirmation configured to cause an indication of the calculated third estimated pick-up time to appear on a display of the third wireless mobile communications device; and
guiding the taxi to a third pick-up location for picking up the third user.

13. The non-transitory computer-readable storage medium according to claim 1, the method further comprising:
receiving a third ride request from a third wireless mobile communications device of a third user, the third ride request including a third starting point and a third desired destination at least one of which is proximate to a route associated with the taxi;
calculating an estimated delay that is expected to occur to the first user if the third user were to be picked up; and
assigning the third ride request to another taxi if the estimated delay exceeds a predetermined detour threshold.

14. The non-transitory computer-readable storage medium according to claim 1, the method further comprising:
assigning a masked phone number for interaction between a wireless mobile communications device of a driver of the taxi and at least one of the first wireless mobile communications device and the second wireless mobile communications device.

15. The non-transitory computer-readable storage medium according to claim 1, the method further comprising:
receiving driver login input from a wireless mobile communications device of a driver of the taxi;
accessing a driver profile database storing driver profiles associated with a plurality of drivers; and
verifying driver identity based on the driver login input and a corresponding driver profile.

16. A system for taxi ridesharing management, comprising:
a memory storing a set of ridesharing-related instructions; and
at least one processor configured to execute the instructions to:
receive, at a taxi ridesharing management server, a first ride request from a first user, the first ride request including a first starting point and a first desired destination;
send a confirmation to the first user with an indication of an estimated pick-up time;
direct a taxi to pick up the first user at a pick-up location;
after pick-up of the first user, receive at the taxi ridesharing management server, a second ride request from a second user, the second ride request including a second starting point and a second desired destination;
direct the taxi to pick up the second user at a second pick-up location while the first user is in the taxi; and
send to the first user a fare amount including a first fare portion corresponding to a first portion of the ride before picking up the second user and a second fare portion corresponding to a second portion of the ride after picking up the second user.

17. The system of claim 16, wherein the at least one processor is further configured to execute the instructions to:
set the second pick-up location at least a half a block away from the second starting point.

18. The system of claim 16, wherein the at least one processor is further configured to execute the instructions to:
set the second pick-up location at substantially a same location as the first pick-up location.

19. The system of claim 16, wherein the first pick-up location is selected to substantially differ from the first starting point and wherein the second pick-up location is selected by the system to substantially differ from the second starting point, and the system is further configured to guide the first user to the first pick-up location and to guide the second user to the second pick-up location.

20. The system of claim 16, wherein the first pick-up location is substantially the same as the first starting point and wherein the second pick-up location is selected by the system to substantially differ from the second starting point, and the system is further configured to guide the second user to the second pick-up location.
